(19) United States
(12) Patent Application Publication
(10) Pub. No.: US 2011/0286799 A1
(43) Pub. Date: Nov. 24, 2011

(54) COMPOUND FOR AGRICULTURAL SOIL

(76) Inventors: Diana Lilia Villafana de la Garza, Xalapa (MX); Jorge Camps Monter, Xalapa (MX)

(21) Appl. No.: 12/848,875

(22) Filed: Aug. 2, 2010

(30) Foreign Application Priority Data
May 19, 2010 (MX) MX/A/2010/005496

(51) Int. Cl. B09C 1/08; C05C 11/00; C05C 9/00; C05F 3/00; C05F 11/00

(52) U.S. Cl. 405/128.5; 71/21; 71/22; 71/23; 71/27; 71/29

(57) ABSTRACT

The present invention consists of a compound that has the capacity to restore, remineralize, and bioactivate agricultural soil. This invention is composed of the following elements: zeolite, humic acid, calcium carbonate, dolomite lime, nitrogen, phosphorus, potassium, and organic material. The invention also encompasses the fabrication process needed to produce this compound for agricultural soil. The invention also encompasses the uses of the invention to improve soil fertility as well as the physical and chemical properties that permit it to bioactivate and remineralize soil. The combination of minerals, N—P—K nutrients, organic material, and humic acid from leonardite, use zeolite-clinoptilolite as a mineral transport system; when it reacts with the other components of the invention, the zeolite-clinoptilolite modifies their external structure and thus produces a remineralizing effect, without limiting the solution's ion-cation exchange capacity. This permits an optimum use of all of the solution's nutrients.

### FIELD OF THE INVENTION

The present invention relates to a compound that has the capacity to restore, remineralize, and bioactivate agricultural land. The invention also covers the process undergone to produce this compound as well as its uses.

### JUSTIFICATION OF THE INVENTION

Food production does not depend exclusively on the use of a particular fertilizer, organic or inorganic; rather, it depends basically on soil fertility, the sustainable use of soil, and application of best agricultural practices.

The FAO has warned that over the next twenty years, food production will have to double in order to satisfy the demands of a growing world population that is expected to stabilize near the end of this century at 10 billion inhabitants.

In its study titled “The State of Food and Agriculture 2003,” the FAO indicated that on a global scale, the farmland surface area per capita had reached 0.82 ha, 27.9% of which corresponded to cropland used for agricultural production.

Also, the world is faced with the problem of land degradation due not only to erosion (in both hydric and eolic forms) but to salinization and other biological, chemical, and physical degradation processes.

Unsustainable farmland management may reach a point where the transformations and damage caused are irreversible due to the vast time period that the formation of these land soils required—from 500 to 1,000,000 years, depending on factors such as the climate prevalent during their development and the type of rock from which they originated. Thus, soil should be considered a “non-renewable resource.”

Despite the fact that the problem is being taken seriously by many countries and organizations such as the United Nations, it is intensifying due to the fact that soil degradation is largely misunderstood, as are the composition and the mechanisms needed to restore soil.

Soil is a complex natural substrate derived from the disintegration and decomposition of rocks and organic material; it provides the nutrients, humidity, and rooting medium that plants require in order to grow.

Soil originates from mother rock, and its optimal composition should approximate the following percentages: 45% of its components are minerals, 25% water, 25% air, and 5% organic matter. When soil is treated in order to restore its fertility and—in consequence—permit the fulfillment of production-related objectives, this composition must be kept in mind.

The lack of chemical and fertility-related soil analyses and the uncontrolled and excessive application of chemical fertilizers has caused imbalances in the proportion of nutritional and biological elements in the soil.

Fertilizers that provide major, secondary, and minor elements must satisfy the nutritional demands of plants, as productivity is dependent on soil fertility; that is to say, its composition and physical characteristics determine the soil's ability to provide plants with the nutrients that they require in order to realize their metabolic functions. The main objective of this invention is to recover or restore soil fertility as a basic requirement of agricultural production.

A fundamental and frequently misunderstood aspect of agriculture is that plants are autotrophic—that is, unlike animals, which acquire nutrition through the ingestion of various products, plants synthesize their own nutritional elements.

From the soil, plants absorb mineral elements; through photosynthesis, they transform them into the proteins, carbohydrates, and enzymes that are necessary for metabolic processes that eventually lead to the production and quality of food. This invention therefore addresses soil improvement because it is the first link in a productive chain that ultimately becomes the basis of a food chain.

### CONCLUSIONS RELATING TO THIS BACKGROUND INFORMATION

Considering the depletion and erosion that soils suffer when they are used as farmland, and to find a solution for the problem humanity faces in terms of continuing to produce food from these damaged soils, production must be made more efficient; to do this, agricultural practices must be sustainable and the soil must be regenerated. It is noteworthy that only ¼ of the food produced will come from open areas that have not been farmed previously, while the other ¾ will have to come from land that is presently farmed.

Within the framework of this invention, restorative capacity is defined as a quick and ongoing way of returning lost fertility to soil through remineralization and bioactivation processes that provide soil with balanced nutrients and improve its physical and chemical characteristics.

The present invention includes the use of a new term, “soil remineralization”; it must be understood as the action of returning to the soil minerals taken from it by crops, minerals that traditional fertilizers do not provide. “Soil remineralization” is closely linked to the natural disintegration process of mother rock.

The term “bioactivation” refers to this invention's ability to promote the growth and development of beneficial microorganisms in the soil.

This invention will thus benefit the soil; within a period of three years, application of the compound will have practically restored its original fertility. This will provide a firm foundation on which best agricultural practices and sustainable development can be based, guaranteeing sufficient food production to meet the demands of a growing population.

### PURPOSE OF THE INVENTION

The present invention refers to the compound of an agricultural soil amendment that restores minerals, provides nutrients, humic substances, and organic matter, thus increasing soil fertility and improving its texture and structure while respecting its original composition.

### OVERVIEW OF THE INVENTION

The production process for this invention involves making a blend of zeolite, humic acid, calcium carbonate, dolomite lime, and organic material in proportions that allow the invention to exert a replenishing action and to promote the natural fertility of agricultural soils.

The invention is based on the principals of sustainability, best agricultural practices, and the innocuous production of food, as it is irrefutable that healthy soil bears healthy plants, from which healthy food can be produced.

The invention arises from the understanding that soil is a composite of physical and chemical elements in a habitat characterized by specific microorganisms and small animals; it requires careful management in order for the biotic balance to be preserved.

The organic material involved in the present invention is vegetative in nature. It is mineralized quickly and delivers nutrients to the soil in an efficient manner due to its degraded state and because it has been previously enriched, composted, ground, and sieved.

The invention promotes an increase in the ion-cation exchange capacity of soil, thus making nutrients in the soil solution more accessible to plants and chemical and organic fertilizers more effective.

### BRIEF DESCRIPTIONS OF FIGURES

FIG. 1 shows a microscopic image of crystals of zeolite-clinoptilolite, which constitute the nutrient-transport elements, and the other components of the invention.

FIG. 2 shows the positive effect of the humic components of the invention on preventing lixiviation of nutrients in the soil, due to its ability to increase cation exchange.

FIG. 3 shows the atomic tetrahedric, and crystalline structure of zeolite-clinoptilolite. This structure is what justifies the invention's being considered to feature a transport agent for the formula included in it.

FIG. 4 shows the difference between zeolite-clinoptilolite in its natural state and the state of this invention when it is imbued with nutrients.

FIG. 5 illustrates the remineralization concept by showing what happens in the soil when the invention is subjected to rainwater or irrigation.

FIG. 6 provides the results of the tests run in accordance with NOM-077-fito-2000, which establishes the requirements and specifications to carry out biological effectiveness studies on plant nutriments. Here, the yields for coffee cherry and green coffee are shown. From Graph I, we can conclude that under all treatments that involve using the invention, results are statistically superior to those of the control treatment (T0). The first level of the invention proved equal to the second level, and the first level of the invention with a chemical fertilizer added proved equal to the second also with fertilizer added. This demonstrates the efficiency of application of the invention. Graph 2 shows the yield in kilograms per hectare after six months of treatment application and after the coffee beans were processed. Treatments generated dramatic statistical differences, indicating that at least one of the treatments had different results. All treatments that involved application of the invention were superior to the control treatment (T0).

FIG. 7 shows the results of the tests run in accordance with NOM-077-fito-2000, which establishes the requirements and specifications for the realization of biological effectiveness studies on plant nutriments. Yields for toasted coffee beans and the density of green coffee beans are shown. Graph 3 illustrates the average differences (%) between the low and high levels of application of the invention; the average of the lowest and highest results for the invention was 25.67% lower than the average of the lowest and highest results for the invention with a fertilizer supplement. The highest yield (T4) was 76.05% higher than the control yield. Graph 4 indicates that the results showed significant differences between treatments involving application of the invention alone and those involving the invention plus chemical fertilizer. There were no significant differences among results for treatments involving only application of the invention. Thus, the average for control treatments was 23.9% lower than the average for treatments involving only application of the invention.

FIG. 8 indicates the time required for the formation of agricultural soil in two scenarios with different climatic conditions, a tropical and dry climate.

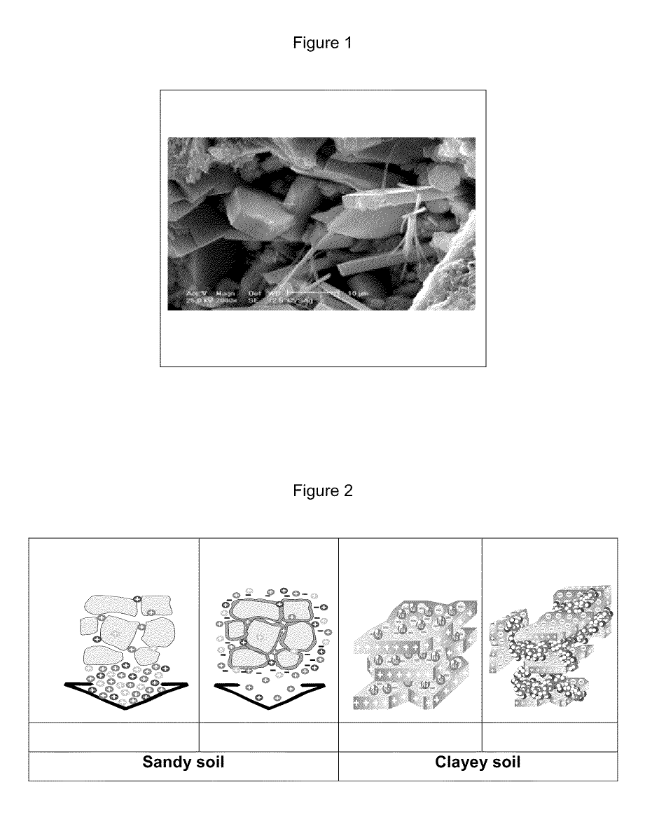

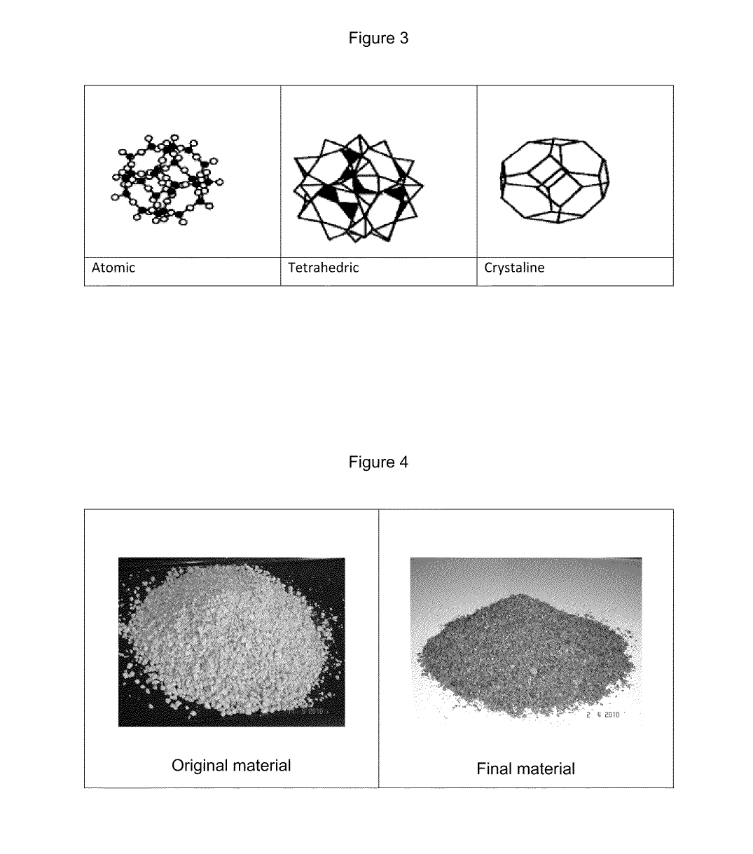

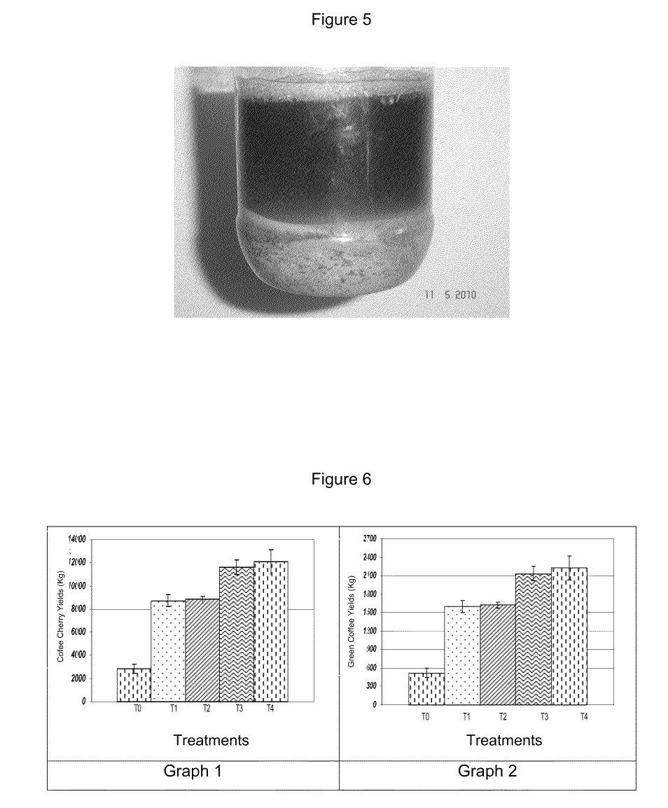

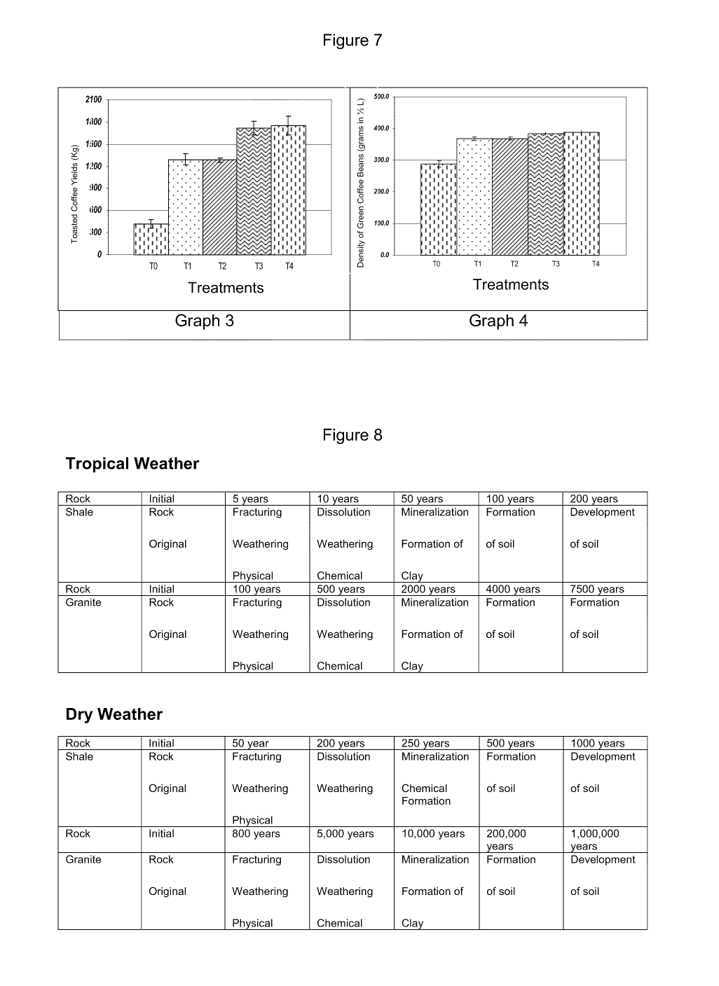

### DETAILED DESCRIPTION OF THE INVENTION

The first aspect of the invention to be addressed relates to the production process of this soil amending compound. Due to its manufacturing process, its amalgamation boosts the effect of the following ingredients: zeolite, nitrogen, phosphorus, potassium, dolomite lime, calcium carbonate, humic acid, and organic material compost; because of the production process, they acquire a new chemical composition as well as new physical properties due to the interaction and reaction of these ingredients.

Derived from a manufacturing process that brings about structural and chemical modifications in the original components, the invention becomes a soil restorer that has unique characteristics that are superior to those of each component when applied individually.

Zeolite is subjected to an impregnation and enrichment process that involves the use of a nutrient-laden solution consisting of nitrogen, phosphorus, potassium, humic acid, and water. First, this solution is added to the zeolite. Once it has acquired enough moisture to absorb minerals, dolomite lime and calcium carbonate are added, forming a homogenized mixture; application of the nutrient-laden solution continues simultaneously, until complete absorption by the zeolite has occurred. Once the zeolite has absorbed both the minerals and the nutrient-laden solution, the organic material—previously composted, ground, and sieved almost to a powdery texture—is added. The mixing process continues until the organic material has been thoroughly incorporated and pelletization has occurred.

Formulation of the nutrient-laden solution used to imbue the zeolite with nutrients is composed of 65-90 liters of water with a pH of 7.0-7.5 and a maximum of 90 ppm of suspended solids, between 10-35 liters of humic acid, 4.5-15.30 kg of urea, and 6.81-22.72 kg of a soluble formula containing nitrogen, phosphorus, and potassium (NPK) 13-2-44, or NPK formula 14-0-40, or a similar formula, preferably the formula NPK 13-2-44.

The water is added first, followed by the urea and the soluble 13-2-44 formula; this is shaken for 15 minutes. Immediately afterward, the humic acid is added and the mixture is shaken continuously for 12 hours in order for it to stabilize completely. Once this process has been completed, the solution is ready to imbue the zeolite with nutrients.

In terms of percentages, the impregnation process herein defined consists of adding 50% of the nutrition-laden solution described above to 75% zeolite. Afterward, 10% dolomite lime is added, followed by 5% calcium carbonate and the remaining 50% of the nutrition-laden solution, permitting the dilution of the minerals and facilitating their absorption by the zeolite. Once the zeolite has been impregnated—that is, imbued with nutrients and minerals—the mixture is supplemented with 10% organic material; mixing continues until pelletization has been achieved.

Zeolite: zeolites belong to the family of tectosilicates and are crystalline aluminosilicates, the structure of which features channels and cavities of molecular dimensions, in which compensation cations are found along with water molecules or other adsorbates and salts.

This type of microscopic structure gives zeolites an extremely large internal surface of between 500 and 1000 m²/g, in relation to the external surface. The amount used in the present invention runs from 500-750 kg per metric ton of the final product.

The molecular formula of zeolite is as follows: (Na, K, Ca_{0.5}, Sr_{0.5}, Ba_{0.5}, Mg_{0.5})₆[AI₆Si₃₀O₇₂].˜20H₂O. The zeolite used here belongs to the heulandite family, along with laumontite and mordenite; preferably, clinoptilolite is used.

The average composition of the zeolite-clinoptilolite used is as follows: Na₂O=5.36%; MgO=1%; AI₂O₃=11.50%; SiO₂=65.70%; K₂O=2.44%; CaO=1.34%; Fe₂O₃=1.66%; loss due to calcination=10.35%; cation exchange capacity=120 meq/100 g. These percentages may vary slightly depending on the mine. The zeolite-clinoptilolite used can vary in sizes from 2-4 mm.

Nitrogen is an essential element for plant development but is equally vital to the development and proliferation of microorganisms that are beneficial to soil. The present invention incorporates ureic and ammoniacal nitrogen in varying amounts, depending on the desired final concentration. To obtain concentrations in a range of 3-10% of nitrogen per metric ton of final product, one uses 5.59-15.30 kg of urea and 6.81-22.72 kg of the NPK 13-2-44 or NPK 14-0-40 soluble formula, or any other source of soluble N, any other source of soluble P, or any other source of soluble K.

Phosphorus is also an essential element and is highly immobile in soil. In this invention, it is used in amounts that vary, depending on the final concentration desired. To obtain concentrations in a range of 1-5% of phosphorus per ton of finished product, one uses 6.81-22.72 kg of the NPK 13-2-44 or 14-0-40 soluble formula, or any other soluble source of N, any other source of soluble P, or any other source of soluble K.

Potassium is also a required element in plants development. In this invention, it is used in amounts that vary, depending on the final concentration desired. To obtain concentrations in a range of 3-10% of potassium per ton of finished product, one uses 6.81-22.72 kg of the NPK 13-2-44 or 14-0-40 soluble formula, or any other soluble source of N, any other source of soluble P, or any other source of soluble K.

Through this procedure, we will obtain 3-10% nitrogen, 1-5% phosphorus, and 3-10% potassium, depending on the final concentration desired.

To achieve the bioactivating effect on soil, humic acid or humic lixiviates are incorporated; however, preferably the humic acid used in this invention is obtained from leonardite due to its purity, which varies from 70-90%. Leonardite is a form of humic acid found in North Dakota. It is named after Dr. A. G. Leonard, the first Director of the State of North Dakota's Geological Service and the first scientist to study the properties of this particular substance.

Due to its origin (organic ethers and esters in Paleozoic vegetation), leonardite is exceptional due to its capacity to increase biological activity in soil; leonardite has been demonstrated to be up to eight times more effective than humic acids from other sources in this regard. The formation of leonardite began in the carboniferous era of the Paleozoic, around 280 million years ago.

A concentration of leonardite humic acid high enough to cause microorganisms in the soil to react, improving their physical and chemical characteristics, fluctuates between 80-280 liters per metric ton of the finished product.

Dolomite lime provides calcium and magnesium along with trace elements; it neutralizes the soil's pH as well as the toxicity of soluble aluminum, and its role as a soil disinfectant is also well known.

The Granulometric level is 95% using a number 80 mesh, and the product's density is between 2.86-3.10 g/cm³. Its chemical composition is between 17%-26% magnesium oxide, 26-36% calcium oxide, and 41-47% CO₂.

Calcium carbonate provides the product with calcium and magnesium and is a potent corrector of the acidic pH in soil. The composition of this ingredient is as follows: total CaCO₃ can fluctuate between 92-99.0%, 35-45% calcium, 0.5-1% magnesium, 0.07-1% nitrogen, 41-47% CO₂, 50-57% calcium oxide, and 0.5-1% magnesium carbonate. The granulometric level is 95% using a number 80 mesh.

The organic material used is of vegetative origin. Other sources can be the remains of agricultural harvests, dung, or worm compost.

The organic material used in the present invention has the following chemical composition: a pH between 6.5-7.5, 1.5-3.0% N, 0.5-2% P, 1-2% K, 1-7.5% Ca, 0.1-1.0% Mg, 0.1-1.0% Fe, 10-20 mgKg⁻¹ Cu, 100-350 mgKg⁻¹ Zn, 100-400 mgKg⁻¹ Mn, 10-100 mgKg⁻¹ B.

The zeolite-clinoptilolite is subjected to an impregnation process of the major elements N, P, and K, leonardite humic acid, dolomite lime, calcium carbonate, and organic material, all of which is blended until pelletization. The composition of the invention in terms of the major elements N, P, and K varies in the following way, depending on the crop and soil type: a minimum of 3% N and a maximum of 10%, a minimum of 1% P and a maximum of 5%, a minimum of 3% K and a maximum of 10%, and any combination within those minimum and maximum ranges for these elements—although preferably, the amount of lesser elements also falls within the following ranges: 10-18% Ca, 1.5-8.5% Mg, 0.5-1.9% Fe, 6.0-12 mgL⁻¹ Cu, 100-160 mgL⁻¹ Zn, 180-260 mgL⁻¹ Mn, 30-65.0 mgL⁻¹ B.

The invention promotes the amendment and regeneration of soils through remineralization, nutrition, and bioactivation. It complies with best agricultural practices and sustainable farming.

The present invention includes a new term, “soil remineralization,” which can be understood as the action of returning to the soil the minerals extracted by crops and that traditional fertilizers do not provide. “Soil remineralization” follows the natural processes of mother rock disintegration.

Sustainable agriculture can be defined as “a form of production that, in the long run, improves the quality of the environment and the resource base on which it depends, providing an adequate supply of food, being economically viable, and improving the farmer's quality of life.”

Due to its unique characteristics, our invention provides the following benefits: soil remineralization, fertility reactivation, and improvement in the texture and structure of the soil.

When it is used on clayey soil, it is intercalated between layers of clay, liberating nutrients that are retained in them. The soil then becomes spongier and softer. In the case of sandy soil, nutrient loss is avoided by maintaining nutrients in the soil, accessible to the rhyzosphere.

The use of this invention generates a more favorable medium for the development of crop root systems, creating an environment that stimulates the activity of microorganisms that are beneficial to the soil and causing them to multiply.

It improves the efficiency of water use in the soil and increases drainage when rains are heavy, while keeping enough water volume to avoid stress on plants.

It increases the degree of soil airing, which benefits aerobic microorganisms. Due to its particular components, it exercises a buffer effect, correcting the soil's pH through humic substances that facilitate hydrogen-free ions in the soil.

It makes fertilizers more efficient due to the high ion-cation exchange capacity of its components. It gradually liberates nutrients, facilitating their absorption and avoiding lixiviation.

It provides stabilized humic substances that strengthen the carbon, nitrogen, phosphorus, and sulfur cycles. It exercises a chelating action that facilitates the assimilation of nutrients by roots.

It improves the metabolic functions of plants, as reflected in the growth, health, and productivity of crops.

It increases plants natural resistance to disease by strengthening their cell walls and tissues. It neutralizes polluting agents in soil.

Tests Done

The invention has been evaluated in accordance with the Official Mexican NORM NOM-077-fito-2000, which establishes the requirements and specifications for the realization of studies on the biological effectiveness of nutritional agricultural supplies.

Treatments consisted of a control, T0 (without our invention), T1 and T2, with 300 g and 500 g of our invention, respectively, and T3 and T4, which included 1 kg and 1.5 kg of our invention plus 300 g of chemical fertilizer for each treatment.

Five repetitions were done per treatment, generating a total of 25 experimental units that were distributed in a completely randomized design. The experimental design covered a surface of 2500 m².

The graphic results can be observed in the section where the figures are described. However, the following conclusions can be reached:

From Graph 1, it is clear that with all treatments that applied the invention, results were statistically superior to the control treatment (T0). The first level of the invention had comparable results to the second level, and the first level plus fertilizer was also comparable to the second plus fertilizer. This demonstrates the efficiency of the application of the invention. The highest yield (T4) was shown to be 76.6% higher than that of the control. The average of the lowest and highest levels without fertilizer was shown to be 25.94% lower than the average lowest and highest of the invention mixed with fertilizer. Graph 2 shows the yield in kilograms per hectare six months after the treatments were applied and the coffee beans processed.

The treatments showed statistically significant differences, indicating that at least one of the treatments produced a different yield. All treatments that involved application of the invention had results that were statistically superior to those of the control treatment (T0).

Results for treatments involving application of the invention at a low and high level were statistically equal. Treatments involving application of the invention at a low and high level mixed with fertilizer were also statistically equal, but different from the first ones.

Graph 3 shows that statistical differences between treatments were significant, with the result that at least one of the treatments yielded different results. All treatments that involved application of the invention were statistically superior to the control treatment (T0). Treatments with the invention at a low and high level were statistically equal. Those with the invention at a high and low level mixed with fertilizers were also statistically equal, but different from the first two. The average differences in percentages between the low and high level of the invention without the addition of fertilizer as compared to the low and high level for the invention plus the chemical fertilizer were 25.67% lower for the fertilizer-less treatments. The highest yield corresponded to T4; it was 76.05% higher than that of the control.

Graph 4 shows that there were statistically significant differences between the control and the treatments that involved the invention as well as the invention plus fertilizer. In contrast, there were no significant differences between the treatments that involved only application of the invention. As seen in Graph 4, the average for the control was 23.9% lower than the average for treatments that involved the invention and a fertilizer supplement.

In the experimental conditions that characterized this study, it was conclusively shown that the invention promotes crop yields of over 70%, and that fruit quality improves by 23.9% when compared to that of the control treatment.

In general, foliar development also improved, less fruit fell to the ground, the maturation process became more homogenized, and there was an increase in the size and weight of fruit, significantly improving its yield.

For these reasons, the invention can be considered an agent that restores and amends agricultural soil by providing it with plant nutrition, remineralizing it, and reactivating its fertility.

We claim:

1. A composition for agricultural soil comprising:
a nutrient-laden solution, calcium carbonate, dolomite lime, organic material and zeolite,
wherein the nutrient-laden solution includes, water, humic acid, nitrogen, phosphorus, and potassium.

2. The composition according to claim 1, wherein the water has a pH of about 7 and a concentration that does not exceed 90 parts per million of suspended solids.

3. The composition according to claim 1, wherein the humic acid is selected from the group consisting of humic lixiviates and leonardite.

4. The composition according to claim 3, wherein the humic acid has a purity of about 70-90%.

5. The composition according to claim 1, wherein the nitrogen is ureic, ammoniacal, and soluble.

6. The composition according to claim 1, wherein at least a portion of the nitrogen in the nutrient-laden solution is from urea.

7. The composition according to claim 1, wherein at least a portion of the nitrogen in the nutrient-laden solution is from NPK formula.

8. The composition of claim 7, wherein the NPK formula is NPK 13-2-44 or NPK 14-0-40.

9. The composition according to claim 1, wherein at least a portion of the nitrogen in the nutrient-laden solution is from nitric acid.

10. The composition according to claim 1, wherein the phosphorous of the nutrient laden-solution is soluble.

11. The composition according to claim 10, wherein the phosphorous is from NPK formula.

12. The composition according to claim 1, wherein at least a portion of the phosphorous in the nutrient-laden solution is from phosphoric acid.

13. The composition of claim 10, wherein the NPK formula is NPK 13-2-44 or NPK 14-0-40.

14. The composition according to claim 1, wherein the potassium in the nutrient-laden solution is soluble.

15. The composition according to claim 14, wherein the potassium is from NPK formula.

16. The composition of claim 15, wherein the NPK formula is NPK 13-2-44 or NPK 14-0-40.

17. The composition according to claim 1, wherein the calcium carbonate has a concentration that can fluctuate between 92-99%, and further wherein the calcium carbonate has a chemical composition including about 35-45% calcium, about 0.5-1% magnesium, about 0.07-1% nitrogen, about 41-47% carbon dioxide, about 50-57% calcium oxide, and about 0.5-1% magnesium carbonates.

18. The composition according to claim 17, wherein the calcium carbonate has a granulometric level of about 95% passing through an 80 mesh.

19. The composition according to claim 1, wherein the dolomite lime has a chemical composition including about 17-26% magnesium oxide, about 26-36% calcium oxide, and about 41-47% carbon dioxide.

20. The composition according to claim 1, wherein the organic material is selected from the group consisting of plant harvest, agricultural harvest, manure, and worm compost.

21. The composition according to claim 1, wherein the organic material has a pH of about 6.5-7.5.

22. The composition according to claim 21, wherein the organic material comprises about 1.5-3.0% nitrogen, about 0.5-2% potassium, about 1-2% phosphorous, about 1-7.5% calcium, about 0.1-1.0% magnesium, about 0.1-1.0% iron, about 10-20 mgKg⁻¹ copper, about 100-350 mgKg⁻¹ zinc, about 100-400 mgKg⁻¹ manganese, and about 10-100 mgKg⁻¹ boron.

23. The composition according to claim 1, wherein the zeolite is selected from the heulandite family.

24. The composition according to claim 23, wherein the heulandite family is comprised of laumontite, mordenite, and clinoptilolite.

25. The composition according to claim 1, wherein the zeolite is clinoptilolite.

26. The composition according to claim 25, wherein the clinoptilolite has an average composition of about 5.36% Na₂O, about 1% MgO, about 11.5% Al₂O₃, about 65.7% SiO₂, about 2.44% K₂O, about 1.34% CaO, and about 1.66% Fe₂O₃.

27. The composition according to claim 25, wherein the clinoptilolite varies in size from about 2 to 4 mm.

28. A process for manufacturing a composition for restoring agricultural soil, the process comprising:
mixing about 65-90 liters of water and about 10-35 liters of humic acid to form a mixture;
shaking the mixture until it homogenizes or stabilizes;
adding about 4.5-15.30 kilograms of urea and about 6.81-22.72 kilograms of an NPK soluble formula to the mixture;
shaking the mixture until it homogenizes or stabilizes to obtain concentrations of about 3-10% nitrogen, about 1-5% phosphorous, and about 3-10% potassium;
adding zeolite to the mixture at a ratio of about 75% total volume of zeolite to about 50% total volume of the mixture;
adding dolomite lime to the mixture at about 10% total volume;
adding calcium carbonate to the mixture at about 5% total volume;
adding organic material to the mixture at about 10% total volume; and
mixing the mixture until pelletization occurs.

29. A process for manufacturing a composition for restoring agricultural soil, the process comprising:
mixing water and humic acid to form a mixture;
shaking the mixture until it homogenizes or stabilizes;
adding urea and an NPK soluble formula to the mixture;
shaking the mixture until it homogenizes or stabilizes to form a nutrient-laden solution;
adding zeolite to the nutrient-laden solution;
adding dolomite lime to the nutrient-laden solution;
adding calcium carbonate to the nutrient-laden solution;
adding organic material to the nutrient-laden solution; and
mixing the nutrient-laden solution and the zeolite, dolomite lime, calcium carbonate and organic material until pelletization occurs.

30. The process of claim 29, wherein the zeolite, nitrogen, phosphorus, potassium, dolomite lime, calcium carbonate, humic acid and organic material acquire a new chemical composition or physical properties due to interaction during the process.

31. The process of claim 29, wherein the added zeolite is impregnated with the nutrient-laden solution.

32. The process of claim 31, wherein the impregnated zeolite is adsorbent, and further wherein the adsorbent zeolite is capable of adsorbing minerals and organic material.

33. The process of claim 32, wherein the dolomite lime, calcium carbonate, and organic material are added after the zeolite becomes adsorbent.

34. The process of claim 29, wherein the nutrient-laden solution is formed by first adding urea and soluble NPK formula to the water.

35. The process of claim 34, wherein the water, urea and NPK formula are shaken for about 15 minutes.

36. The process of claim 35, wherein the humic acid is added immediately after the mixture is shaken for about 15 minutes.

37. The process of claim 36, wherein the mixture of water, urea, NPK formula and humic acid is continuously mixed for about 12 hours.

38. A method for restoring soil by applying the composition of claim 1.

39. A method according to claim 38, wherein application of the composition restores the soil by at least one of the following: restoring minerals, providing nutrients, humic substances, organic material, increasing soil fertility, and improving the texture of the soil.

40. A method according to claim 38, wherein application of the composition bioactivates and remineralizes the soil.

41. A method according to claim 38, wherein application of the composition restores the fertility of the soil within about three years.
